(19) United States
(12) Patent Application Publication
(10) Pub. No.: US 2026/0201792 A1
(43) Pub. Date: Jul. 16, 2026

(54) SYSTEMS AND METHODS FOR DOWNHOLE ORIENTATION SENSOR DEPLOYMENT

(71) Applicants: Edwin Steele, Etobicoke (CA); Steven Tran, Salt Lake City, UT (US); Adam Tomaszewski, Mississauga (CA); Melody Tripp, Salt Lake City, UT (US)

(72) Inventors: Edwin Steele, Etobicoke (CA); Steven Tran, Salt Lake City, UT (US); Adam Tomaszewski, Mississauga (CA); Melody Tripp, Salt Lake City, UT (US)

(21) Appl. No.: 19/135,664

(22) PCT Filed: Dec. 7, 2023
(86) PCT No.: PCT/US2023/082911

§ 371 Date: Jun. 4, 2025

Related U.S. Application Data
(60) Provisional application No. 63/430,894, filed on Dec. 7, 2022.

(51) Int. Cl. E21B 47/024; E21B 23/14; E21B 47/01; G06F 3/01

(52) U.S. Cl. CPC E21B 47/024; E21B 23/14; E21B 47/01; G06F 3/017

(57) ABSTRACT

A system includes a tool that is deploy able into a drill string on a wireline, the tool having at least one orientation sensor. The system can further have a sensor that is configured to sense a gesture of the tool. A computing device in communication with the depth counter can be configured to receive a signal indicative of an output from at least one sensor corresponding to a gesture of a tool that is deploy able into a drill string on a wireline and permit, in response to receiving the signal indicative of the output from at least one sensor corresponding to the gesture, an initialization of at least one orientation sensor of the tool.

### CROSS-REFERENCE TO RELATED APPLICATION

This application claims priority to and the benefit of the filing date of U.S. Provisional Patent Application No. 63/430,894, filed Dec. 7, 2022, the entirety of which is hereby incorporated by reference herein.

### FIELD

The disclosure relates to systems and methods for using a wireline system in a borehole.

### BACKGROUND

Downhole tools can be deployable into a borehole to measure orientation. Prior to deployment of such downhole tools into the borehole, a sequence, often referred to as a “collar shot,” is performed to provide an initial orientation of the orientation sensors associated with the downhole tool. The downhole tool is prepared for deployment and then inserted into the borehole. Conventionally, to give the operator the opportunity to insert the downhole tool into the borehole before the initial orientation measurements are taken, the operator starts a timer and then inserts the downhole tool into the borehole. When the timer expires, a measurement of the initial orientation of the orientation sensors is taken.

This conventional method often leads to the operator waiting for the timer to expire, which wastes time and delays productivity. Further, the conventional method leaves opportunity for error. For example, if the operator does not insert the downhole tool into the borehole in time, or if the operator does not wait long enough for the timer to expire, inaccurate initial measurements can be taken, which can further render inaccurate any subsequent measurements related to or determined in part based on the initial measurements.

### SUMMARY

Described herein, in various aspects, is a system comprising a tool that is deployable into a drill string on a wireline, the tool comprising at least one orientation sensor. At least one sensor is configured to sense a gesture of the tool. A computing device is configured to be in communication with the at least one sensor that is configured to sense the gesture of the tool. The computing device comprises at least one processor and a memory in communication with the at least one processor, wherein the memory comprises instructions that, when executed by the at least one processor, cause the at least one processor to: receive a signal indicative of an output from at least one sensor corresponding to a gesture of the tool; and permit, in response to receiving the signal indicative of the output from at least one sensor corresponding to the gesture, an initialization of at least one orientation sensor of the tool.

In some aspects, a method can comprise receiving, by a computing device, a signal indicative of an output from at least one sensor corresponding to a gesture of a tool that is deployable into a drill string on a wireline. In response to receiving the signal indicative of the output from at least one sensor corresponding to the gesture, the computing device can permit an initialization of at least one orientation sensor of the tool.

In one aspect, a method can comprise inserting a tool that is coupled to a wireline cable into a drill string. A gesture can be performed to permit an initialization of at least one orientation sensor of the tool, the initialization of at least one orientation sensor comprising storing at least one orientation measurement.

### DESCRIPTION OF THE DRAWINGS

FIG. 1 is schematic diagram of a system as disclosed herein.

FIG. 2 is a block diagram of a computing system for controlling operation of the system as disclosed herein.

FIG. 3 is an exemplary output of a display device of the system of FIG. 1.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” can optionally include plural referents unless the context clearly dictates otherwise. For example, use of the term “a tool” can represent disclosure of embodiments in which only a single tool is provided, as well as disclosure of optional embodiments in which a plurality of such tools are provided.

All technical and scientific terms used herein have the same meaning as commonly understood to one of ordinary skill in the art to which this invention belongs unless clearly indicated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, if further aspects, when values are approximated by use of “approximately,” “substantially,” and “generally,” it is contemplated that values within up to 15%, up to 10%, up to 5%, or up to 1% (above or below) of the particularly stated value can be included within the scope of those aspects.

As used herein, the term “proximal” refers to a direction toward a drill rig or drill operator (and away from a formation or borehole), while the term “distal” refers to a direction away from the drill rig or drill operator (and into a formation or borehole).

As used herein, the terms “optional” or “optionally” mean that the subsequently described event or circumstance may or may not occur, and that the description includes instances where said event or circumstance occurs and instances where it does not.

The word “or” as used herein means any one member of a particular list and can in alternative aspects, unless context dictates otherwise, also include any combination of members of that list.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatuses, systems, and associated methods of using the apparatuses and systems can be implemented and used without employing these specific details. Indeed, the apparatuses, systems, and associated methods can be placed into practice by modifying the illustrated apparatus and associated methods and can be used in conjunction with any other apparatus and techniques conventionally used in the industry.

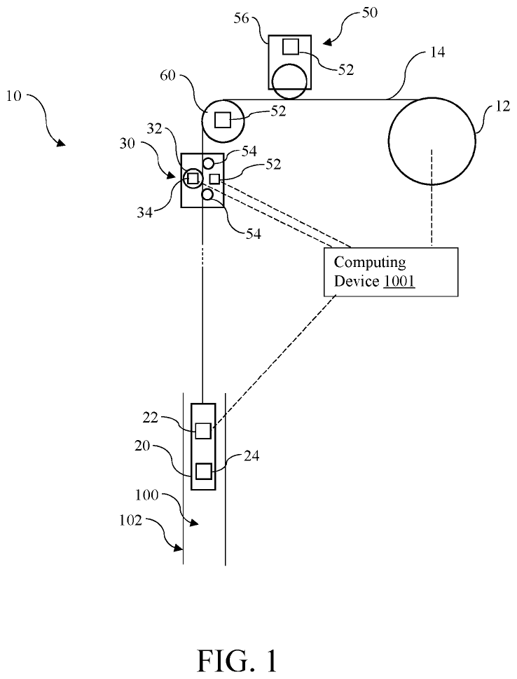

With reference to FIG. 1, disclosed herein, in various aspects, is a drilling system 10 that is configured to acquire data during drilling operations, such as, for example, wireline surveying. In these aspects, the data can relate to orientation of a borehole 102 formed within a formation. In exemplary aspects, the drilling system 10 can comprise a drill string 100 and a wireline tool 20 (also referred to herein as a “tool”) configured for deploying within the drill string 100.

As used herein, the terms “tool” and “wireline tool” interchangeably refer to a mechanical structure comprising an instrument that is deployable and retrievable (e.g., configured to be tripped) within a borehole using a wireline cable. The wireline tool 20 can include an orientation sensor 22. For example, the wireline tool 20 can be a gyroscope (gyro). In other aspects, the wireline tool can comprise a gyro. In further aspects, the wireline tool 20 can comprise one or more additional sensors (i.e., sensors in addition to the orientation sensor), such as, for example and without limitation, pressure sensor(s), magnetic sensor(s), radiation (e.g., gamma ray) detector(s), optical televiewer(s) and/or acoustic televiewer(s), and the like. In further aspects, the wireline tool 20 can comprise a housing or probe structure. In additional aspects, the wireline tool 20 can comprise mechanical tools, such as, for example, a latch structure as is known in the art for engaging an inner tube assembly of a core barrel assembly.

The system 10 can comprise a winch 12 (also referred to as a drum), a wireline cable 14 wound around the winch, and the wireline tool 20, which can be directly or indirectly coupled to the wireline cable 14. In operation, the wireline cable 14 is coupled to the wireline tool 20, and the winch rotates to either increase or decrease the operative length of the wireline cable, thereby controlling a position of the wireline tool 20 with respect to (e.g., within) a drill string 100. As used herein, the term “cable” can refer to an elongated (e.g., flexible, elongated) member that can exert a tensile force during deployment and/or retrieval of a wireline tool. The cable need not provide any electrical communication, although it is contemplated that the cable may optionally provide such communication.

The system 10 can further comprise a wireline depth counter 30 comprising a wheel 32 along which the cable passes. The wireline depth counter 30 can further comprise a rotary encoder 34 that is coupled to the wheel 32. For example, the wireline depth counter 30 can comprise three wheels (e.g., the wheel 32 and two idler pulleys 54) that bias against the cable in alternating directions (as is known in the art) to maintain contact between the three wheels and the cable so that, under optimal circumstances, the wheels each rotate with the cable.

The system 10 can be configured to confirm that the wireline tool 20 is in the borehole before taking and storing one or more initial orientation measurements, referred to herein as “initialization of at least one orientation sensor.” To do so, the system 10 can detect a particular gesture of the tool 20. The gesture of the tool 20 can be indicative of the tool being properly secured to the wireline cable 14 and deployed in the drill string 100 (e.g., a casing). As further described herein, the term “gesture” can refer to a particular movement sequence or pattern that is associated with the tool being secured to the wireline cable 14 and deployed in the drill string 100. In some aspects, the gesture can comprise movement of the tool 20 down the drill string 100 and/or movement of the tool up the drill string. For example, the gesture can comprise movement of the tool down the hole by a first predetermined distance and movement of the tool up the hole by a second predetermined distance (or vice versa). In some aspects, the predetermined distances can serve as a minimum threshold. That is, the gesture does not require that the tool move exactly the predetermined distance, but that it moves at least the predetermined distance. In some optional aspects, the predetermined thresholds can be about 2 inches, or about 3 inches, or from about 1 inch to about 3 inches, or less than 6 inches, or from about 1 inch to about 6 inches, or less than one foot, or from about 1 inch to about one foot, or from about 1 inch to 6 feet. In other aspects, the predetermined thresholds can be greater than 6 feet (e.g., between about 6 feet and about 12 feet or between about 6 feet and about 36 feet).

The system 10 can detect the gesture with one or more sensors. In some aspects, said sensor(s) can include the rotary encoder 34 of the depth counter 30. In further or alternative aspects, although not shown in the drawings, it is contemplated that the sensor(s) for detecting the gesture can include one or more other position sensors, such as for example and without limitation, a proximity (e.g., optical) sensor, a position encoder, a potentiometer, an ultrasonic sensor, a displacement sensor, and the like, with such sensor(s) being associated with the depth counter or the wireline tool. In further or alternative aspects, said sensor(s) can include an inertial sensor 24 (e.g., an accelerometer) that is coupled to (e.g., optionally, integral to) the wireline tool 20.

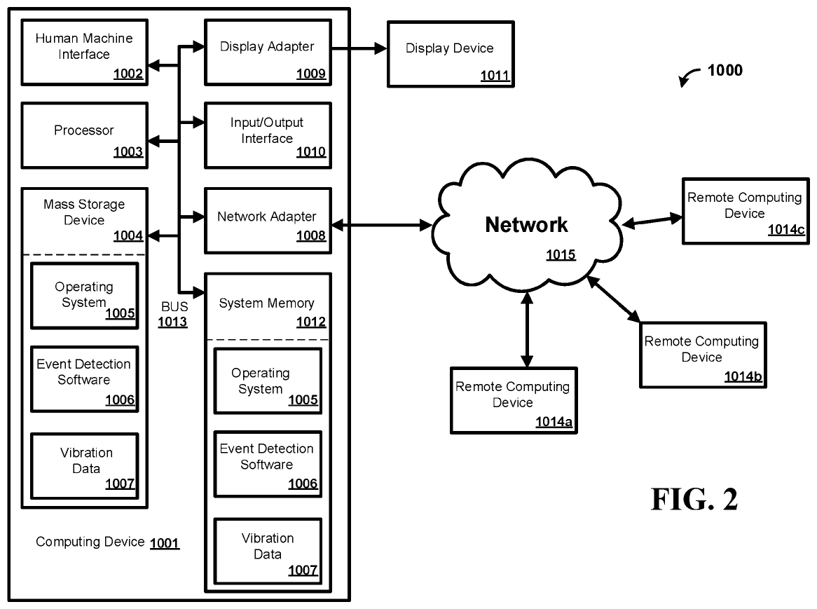

Referring also to FIG. 2, a computing device 1001 can be in communication with, or configured to be in communication with, the sensor(s) that detect the gesture (e.g., the rotary encoder 34 and/or the inertial sensor 24). The computing device can comprise at least one processor (e.g., processor 1003 as shown in FIG. 2) and a memory (e.g., mass storage device 1004) in communication with the at least one processor. The memory can comprise instructions that, when executed by the at least one processor, cause the at least one processor to: receive a signal indicative of an output from at least one sensor (e.g., the rotary encoder 34 or the inertial sensor 24) corresponding to a gesture as further disclosed herein; and permit, in response to receiving the signal indicative of the output from at least one sensor corresponding to the gesture, an initialization of at least one orientation sensor of a tool that is deployable into a drill string on a wireline.

For example, in some aspects, in response to receiving the signal indicative of the output from at least one sensor corresponding to the gesture, the computing device can permit initialization of the at least one orientation sensor by causing the initialization of the orientation sensor. In other aspects, in response to receiving the signal indicative of the output from at least one sensor corresponding to the gesture, the computing device can permit initialization of the at least one orientation sensor by allowing a user (e.g., an operator) to advance a setup routine. For example, the setup routine can be performed by an application of (e.g., executed by) the computing device 1001. In response to receiving the signal indicative of the output from at least one sensor corresponding to the gesture, the application interface can provide the user with a button or other input or interface (e.g., a touchscreen input) that, when selected, causes the initialization of the at least one orientation sensor. In some optional aspects, said button (or other input or interface) can be absent, or the button can be disabled (e.g., grayed out), until the gesture is sensed.

In other aspects, the application can provide the user with a button (or other input or interface) that, when selected, advances the application for the initialization of the at least one orientation sensor. If the user selects this button before the computing device receives the signal indicative of the output from at least one sensor corresponding to the gesture, the computing device 1001 can provide a warning to the user. For example, the warning can be an output on a display (e.g., display device 1011) in communication with the computing device, an audible alarm, or another alarm or other notification. In some aspects, the computing device can require the user to confirm (e.g., by selecting a button or providing other such input) that the user would like to continue with initialization of the at least one orientation sensor, thereby overriding the warning.

In some aspects, in response to receiving the signal indicative of the output from at least one sensor corresponding to the gesture, the computing device 1001 can provide an output to the user (e.g., on a display in communication with the computing device) indicating that the gesture has been detected.

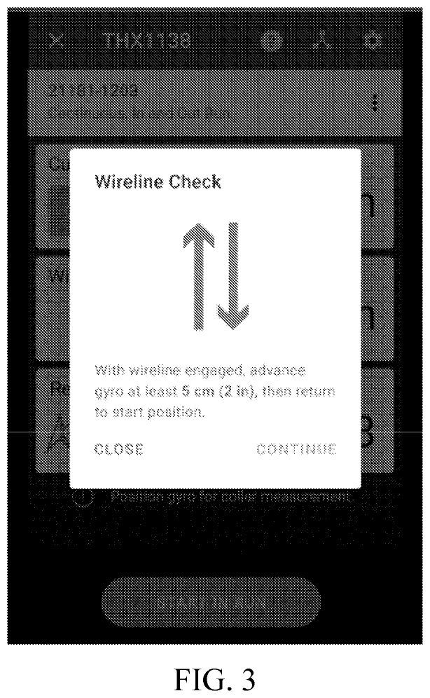

Referring also to FIG. 3, the application can further guide the user through initialization. For example, the display device 1011 can prompt the user to perform the gesture (e.g., cause the tool to follow the movement pattern or sequence associated with the gesture). As illustrated in FIG. 3, the “continue” button is grayed out, indicating that the button is disabled. Upon completion of the gesture, the button can be activated (e.g., no longer grayed out) to permit advancement (e.g., by selecting or pressing the non-grayed out button).

Initialization of the at least one orientation sensor can comprise storing at least one orientation measurement. In some aspects, the at least one orientation measurement can comprise an azimuth measurement and a dip measurement. In some aspects, the at least one orientation measurement of the initialization can be stored in memory of the computing device 1001, or in memory in communication with the computing device (e.g., cloud memory). In some aspects, the at least one orientation measurement of the initialization can be stored in memory of the tool 20.

It can be desirable that the initialization of the at least one orientation sensor 22 of the wireline tool 20 is performed when vibrations are minimal (e.g., with the drill rig not drilling and, optionally, shut down). In this way, the most accurate initial orientation measurements can be taken. Accordingly, in some aspects, and as further disclosed below, at least one inertial sensor 52 (e.g., an accelerometer) that is configured to detect vibrations of the drill rig can be in communication with the computing device. As further described herein, the computing device 1001 can be configured to prevent initialization of the at least one orientation sensor 22 if detected vibrations are above a vibration threshold.

Additionally or alternatively, in some aspects, the computing device 1001 can be configured to determine, based on signals from the inertial sensor, a potential cable slip event (e.g., a wireline slippage detection) and, in response, prevent initialization of the at least one orientation sensor 22 if the potential cable slip event is detected. For example, determining the potential cable slip event can comprise detecting a vibration signature associated with the potential cable slip event. Such cable slip events can occur, for example, at splices along the cable and/or at locations where the cable is subject to wear. In some aspects, the vibration signature can correspond to an increased vibration (e.g., from slipping of the cable off of the wheel and into idlers). In other aspects, the vibration signature can correspond to decreased vibration (e.g., from slipping). It is contemplated that slipping can be caused by various circumstances including environmental buildup such as, for example, ice or mud.

In some aspects, the depth counter 30 can be coupled to the drill rig. Accordingly, the depth counter 30 can be subject to vibrations imparted by the drill rig. In some aspects, the depth counter 30 can comprise the at least one inertial sensor 52 (e.g., an accelerometer) that is configured to detect vibrations. In other aspects, the at least one inertial sensor 52 can be coupled to the drill rig elsewhere (at a location different than the depth counter 30). For example, in some aspects, the at least one inertial sensor 52 can be coupled to (e.g., integral to) the wireline tool 20. In further or alternative aspects, a stand-alone device 50 can measure vibrations of the drill rig or the cable. For example, the stand-alone device 50 can comprise a wheel 54 (e.g., optionally, a pulley/sheave) having an inertial sensor 52 coupled thereto, and the stand-alone device 50 can be positioned against the cable 14 to measure vibrations of the cable. The wheel 54 can transfer the vibrations from the cable to the inertial sensor 52. For example, the wheel 54 can transfer the vibrations from the cable 14 to the frame 56, and the frame can, in turn, transfer the vibrations to the inertial sensor. In still further aspects, the inertial sensor 52 can be coupled to a wheel 60 (e.g., pulley/sheave) of a wireline or drill rig. The inertial sensor 52 can comprise, for example, an accelerometer or an inertial measurement unit (IMU).

The at least one inertial sensor 52 can be in communication with the computing device 1001. The memory of the computing device 1001 can comprise instructions that, when executed by the at least one processor, cause the at least one processor to receive, from the at least one inertial sensor 52, a signal indicative of vibrations above a threshold and prevent the initialization of at least one orientation sensor in response to receiving the signal indicative of vibrations above the threshold. In some optional aspects, the threshold can correspond to a level above which the drill rig is likely running (e.g., with the drive unit of the drill rig idling or otherwise not shut off). In some optional aspects, the threshold can correspond to a level above which the drill rig is likely drilling (e.g., during periods including driven contact between a drill bit and the bottom of a hole).

For example, in some aspects, in response to receiving the signal indicative of vibrations above the threshold, the computing device 1001 can disable advancement of the application performing the setup routine (e.g., by disabling a button or other input interface that permits advancement). In other aspects, in response to receiving the signal indicative of vibrations above the threshold, the computing device can prevent initialization of at least one orientation sensor by providing a warning to the user. For example, the warning can be an output (e.g., text and/or graphical output) on a display (e.g., display device 1011) in communication with the computing device, an audible alarm, or another alarm or other notification. In some aspects, the computing device can require the user to confirm (e.g., by selecting a button or providing other such input) that the user would like to continue with initialization of the at least one orientation sensor, thereby overriding the warning.

Referring to FIG. 1, a method can comprise inserting a tool 20 that is coupled to a wireline cable 14 into a drill string 100. A gesture (e.g., a pattern of movement by the tool 20 as further described herein) can be performed to permit an initialization of at least one orientation sensor of the tool, the initialization of at least one orientation sensor comprising storing at least one orientation measurement. For example, the operator can move the tool 20 in the drill string via the wireline cable 14. In some optional aspects, upon performing the gesture, the initialization of at least one orientation sensor of the tool can be performed (e.g., automatically, without further user input). In other aspects, upon performing the gesture, an application can permit the user to advance the application (e.g., through the interface of the application) in order to cause initialization of at least one orientation sensor of the tool.

In some aspects, inserting the tool 20 can comprise inserting the tool into the proximal end of the drill string during a collar shot. Accordingly, the method can determine an orientation of an upper end portion of a collar in a borehole.

In some aspects, a method can comprise receiving, by a computing device 1001, a signal indicative of an output from at least one sensor corresponding to a gesture. In response to receiving the signal indicative of the output from at least one sensor corresponding to the gesture, the computing device can permit an initialization of at least one orientation sensor of a tool that is deployable into a drill string on a wireline.

The signal indicative of the output from at least one sensor corresponding to the gesture can comprise a signal measured by a depth counter corresponding to at least one change in depth of the tool.

The signal indicative of the output from at least one sensor corresponding to the gesture can comprise a signal from an inertial sensor 24 of the tool 20.

In some aspects, the method can further comprise detecting, by an inertial sensor, a vibration above a threshold. In response to detecting the vibration above the threshold, the computing device can prevent the initialization of the at least one orientation sensor.

In some aspects, permitting the initialization can comprise causing the initialization. In other aspects, permitting the initialization can comprise permitting a user to cause, by providing an input from an input device, the computing device to cause the initialization.

In some aspects, the method of can further comprise outputting, on a display device in communication with the computing device, an instruction to perform the gesture.

Thus, in use, after the system has been initialized by the user (i.e. all devices turned on to begin logging), the user can be asked to perform the gesture with the tool. For example, the user may be asked to insert the tool (e.g., gyro) into the collar position and do a specific up/down movement (or other gesture) to indicate to a firmware or software application (e.g., query/merge algorithm) of the tool that the tool is in the collar position and that a specific measurement or any valid measurement thereafter will be used to calculate a well path. It is contemplated that a gesture recognition timestamp by the application of the tool at or around the time of the motion/gesture can serve as a flag to ensure that the correct, valid measurement is selected for use in the survey result. The ability to identify valid measurements in this manner is important since there can be multiple north seeking measurements taken after tool initialization, but prior to inserting the drill rod at the desired collar position. Thus, it is contemplated that the disclosed systems and methods can provide significant advantages in operational efficiency when deploying a surveying tool (e.g., gyro).

### Computing Device

FIG. 2 shows a computing system 1000 including an exemplary configuration of a computing device 1001 for use with the drilling system 10. In some aspects, the computing device 1001 can be embodied as a smartphone or tablet (FIG. 3), as disclosed herein. In further aspects, it is contemplated that a separate computing device, such as, for example, a tablet, laptop, or desktop computer can communicate with the system 10 and can enable the user to interface with the system 10.

The computing device 1001 may comprise one or more processors 1003, a system memory 1012, and a bus 1013 that couples various components of the computing device 1001 including the one or more processors 1003 to the system memory 1012. In the case of multiple processors 1003, the computing device 1001 may utilize parallel computing.

The bus 1013 may comprise one or more of several possible types of bus structures, such as a memory bus, memory controller, a peripheral bus, an accelerated graphics port, and a processor or local bus using any of a variety of bus architectures.

The computing device 1001 may operate on and/or comprise a variety of computer readable media (e.g., non-transitory). Computer readable media may be any available media that is accessible by the computing device 1001 and comprises, non-transitory, volatile and/or non-volatile media, removable and non-removable media. The system memory 1012 has computer readable media in the form of volatile memory, such as random access memory (RAM), and/or non-volatile memory, such as read only memory (ROM). The system memory 1012 may store data such as vibration data 1007 (i.e., data from signals received by an inertial sensor) and/or program modules such as operating system 1005 and gesture detection software 1006 that are accessible to and/or are operated on by the one or more processors 1003.

The computing device 1001 may also comprise other removable/non-removable, volatile/non-volatile computer storage media. The mass storage device 1004 may provide non-volatile storage of computer code, computer readable instructions, data structures, program modules, and other data for the computing device 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 1004. An operating system 1005 and gesture detection software 1006 may be stored on the mass storage device 1004. One or more of the operating system 1005 and gesture detection software 1006 (or some combination thereof) may comprise program modules and the gesture detection software 1006. The vibration data 1007 may also be stored on the mass storage device 1004. The vibration data 1007 may be stored in any of one or more databases known in the art. The databases may be centralized or distributed across multiple locations within the network 1015.

A user may enter commands and information into the computing device 1001 using an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like. These and other input devices may be connected to the one or more processors 1003 using a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

A display device 1011 may also be connected to the bus 1013 using an interface, such as a display adapter 1009. It is contemplated that the computing device 1001 may have more than one display adapter 1009 and the computing device 1001 may have more than one display device 1011. A display device 1011 may be a monitor, an LCD (Liquid Crystal Display), light emitting diode (LED) display, television, smart lens, smart glass, /d/ or a projector. In addition to the display device 1011, other output peripheral devices may comprise components such as speakers (not shown) and a printer (not shown) which may be connected to the computing device 1001 using Input/Output Interface 1010. Any step and/or result of the methods may be output (or caused to be output) in any form to an output device. Such output may be any form of visual representation, including, but not limited to, textual, graphical, animation, audio, tactile, and the like. The display 1011 and computing device 1001 may be part of one device, or separate devices.

The computing device 1001 may operate in a networked environment using logical connections to one or more remote computing devices 1014a,b,c. A remote computing device 1014a,b,c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computing device 1001 and a remote computing device 1014a,b,c may be made using a network 1015, such as a local area network (LAN) and/or a general wide area network (WAN), or a Cloud-based network. Such network connections may be through a network adapter 1008. A network adapter 1008 may be implemented in both wired and wireless environments. Such networking environments are conventional and commonplace in dwellings, offices, enterprise-wide computer networks, intranets, and the Internet. It is contemplated that the remote computing devices 1014a,b,c can optionally have some or all of the components disclosed as being part of computing device 1001. In some optional aspects, the remote computing devices 1014a,b,c can be in direct communication with each other and the computing device 1001. In various further aspects, it is contemplated that some or all aspects of data processing described herein can be performed via cloud computing on one or more servers or other remote computing devices. Accordingly, at least a portion of the system 1000 can be configured with internet connectivity.

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A method comprising:
receiving, by a computing device, a signal indicative of an output from at least one sensor corresponding to a gesture of a tool that is deployable into a drill string on a wireline; and
permitting, by the computing device, in response to receiving the signal indicative of the output from at least one sensor corresponding to the gesture, an initialization of at least one orientation sensor of the tool.

Aspect 2: The method of aspect 1, wherein the signal indicative of the output from at least one sensor corresponding to the gesture comprises a signal measured by a depth counter corresponding to at least one change in depth of the tool.

Aspect 3: The method of aspect 1, wherein the signal indicative of the output from at least one sensor corresponding to the gesture comprises a signal from an inertial sensor of the tool.

Aspect 4: The method of aspect 1, further comprising:
detecting, by an inertial sensor, a vibration above a threshold or a wireline slippage detection; and
preventing, by the computing device, the initialization of at least one orientation sensor in response to detecting the vibration above the threshold or a wireline slippage detection.

Aspect 5: The method of any one of the preceding aspects, wherein the initialization of at least one orientation sensor comprises storing at least one orientation measurement.

Aspect 6: The method of aspect 5, wherein storing at least one orientation measurement comprises storing the at least one orientation measurement in memory of the computing device or memory in communication with the computing device.

Aspect 7: The method of aspect 5, wherein storing at least one orientation measurement comprises storing the at least one orientation measurement in memory of the tool.

Aspect 8: The method of any one of aspects 5-7, wherein storing at least one orientation measurement comprises storing an azimuth measurement and a dip measurement.

Aspect 9: The method of any one of the preceding aspects, wherein permitting the initialization comprises causing the initialization.

Aspect 10: The method of any one of the preceding aspects, wherein permitting the initialization comprises permitting a user to cause, by providing an input from an input device, the computing device to cause the initialization.

Aspect 11: The method of any one of the preceding aspects, further comprising outputting on a display device in communication with the computing device, an instruction to perform the gesture.

Aspect 12: The method of any one of the preceding aspects, wherein the gesture comprises at least one of:
moving the tool down the drill string; or
moving the tool up the drill string.

Aspect 13: A method comprising:
inserting a tool that is coupled to a wireline into a drill string; and
performing a gesture to permit an initialization of at least one orientation sensor of the tool, wherein the initialization of at least one orientation sensor comprises storing at least one orientation measurement.

Aspect 14: A system comprising:
a tool that is deployable into a drill string on a wireline, the tool comprising at least one orientation sensor;
at least one sensor that is configured to sense a gesture of the tool; and
a computing device configured to be in communication with the at least one sensor that is configured to sense the gesture of the tool, wherein the computing device comprises at least one processor and a memory in communication with the at least one processor, wherein the memory comprises instructions that, when executed by the at least one processor, cause the at least one processor to:
   receive a signal indicative of an output from at least one sensor corresponding to a gesture of the tool; and
   permit, in response to receiving the signal indicative of the output from at least one sensor corresponding to the gesture, an initialization of at least one orientation sensor of the tool.

Aspect 15: The system of aspect 14, wherein the signal indicative of the output from at least one sensor corresponding to the gesture comprises a signal measured by a depth counter corresponding to at least one change in depth of the tool.

Aspect 16: The system of aspect 14, wherein the signal indicative of the output from at least one sensor corresponding to the gesture comprises a signal from an inertial sensor of the tool.

Aspect 17: The system of aspect 14, further comprising:
an inertial sensor configured to be in communication with the computing device;
wherein the memory comprises instructions that, when executed by the at least one processor, cause the at least one processor to:
   receive, from the inertial sensor, a signal indicative of vibrations above a threshold or a wireline slippage detection; and
   prevent, by the computing device, the initialization of at least one orientation sensor in response to receiving the signal indicative of vibrations above the threshold or a wireline slippage detection.

Aspect 18: The system of aspect 17, wherein the system comprises a depth counter that is configured to couple to the wireline, wherein the depth counter comprises the inertial sensor.

Aspect 19: The system of any one of aspects 14-18, wherein the initialization of at least one orientation sensor comprises storing at least one orientation measurement.

Aspect 20: The system of aspect 19, wherein the computing device is configured to store the at least one orientation measurement in memory of the computing device or memory in communication with the computing device.

Aspect 21: The system of aspect 19, wherein the tool is configured to store the at least one orientation measurement in memory of the tool.

Aspect 22: The system of any one of aspects 19-21, wherein storing at least one orientation measurement comprises storing an azimuth measurement and a dip measurement.

Aspect 23: The system of any one of aspects 14-22, wherein the computing device is configured to permit the initialization by causing the initialization.

Aspect 24: The system of any one of aspects 14-23, wherein the computing device is configured to permit the initialization by permitting a user to cause, by providing an input from an input device, the computing device to cause the initialization.

Aspect 25: The system of any one of aspects 14-24, further comprising a display device in communication with the computing device, wherein the computing device is configured to output, on the display device, an instruction to perform the gesture.

Aspect 26: The system of any one of aspects 14-25, wherein the gesture comprises at least one of:
moving the tool down the drill string; or
moving the tool up the drill string.

Although the foregoing invention has been described in some detail by way of illustration and example for purposes of clarity of understanding, certain changes and modifications may be practiced within the scope of the appended claims.

1. A method comprising:
receiving, by a computing device, a signal indicative of an output from at least one sensor corresponding to a gesture of a tool that is deployable into a drill string on a wireline; and
causing, by the computing device, after receiving the signal indicative of the output from at least one sensor corresponding to the gesture, an initialization of at least one orientation sensor of the tool.

2. The method of claim 1, wherein the signal indicative of the output from at least one sensor corresponding to the gesture comprises a signal measured by a depth counter corresponding to at least one change in depth of the tool.

3. The method of claim 1, wherein the signal indicative of the output from at least one sensor corresponding to the gesture comprises a signal from an inertial sensor of the tool.

4. The method of claim 1, further comprising:
detecting, by an inertial sensor, a vibration above a threshold or a wireline slippage detection; and
preventing, by the computing device, the initialization of at least one orientation sensor in response to detecting the vibration above the threshold or a wireline slippage detection.

5. The method of claim 1, wherein the initialization of at least one orientation sensor comprises storing at least one orientation measurement.

6. The method of claim 5, wherein storing at least one orientation measurement comprises storing the at least one orientation measurement in memory of the computing device or memory in communication with the computing device.

7. The method of claim 5, wherein storing at least one orientation measurement comprises storing the at least one orientation measurement in memory of the tool.

8. The method of claim 5, wherein storing at least one orientation measurement comprises storing an azimuth measurement and a dip measurement.

9. (canceled)

10. The method of claim 1, wherein the computing device causes the initialization in response to a user providing an input from an input device.

11. The method of claim 1, further comprising outputting on a display device in communication with the computing device, an instruction to perform the gesture.

12. The method of claim 1, wherein the gesture comprises at least one of:
moving the tool down the drill string; or
moving the tool up the drill string.

13. (canceled)

14. A system comprising:
a tool that is deployable into a drill string on a wireline, the tool comprising at least one orientation sensor;
at least one sensor that is configured to sense a gesture of the tool; and
a computing device configured to be in communication with the at least one sensor that is configured to sense the gesture of the tool, wherein the computing device comprises at least one processor and a memory in communication with the at least one processor, wherein the memory comprises instructions that, when executed by the at least one processor, cause the at least one processor to:
receive a signal indicative of an output from at least one sensor corresponding to a gesture of the tool; and
cause, after receiving the signal indicative of the output from at least one sensor corresponding to the gesture, an initialization of at least one orientation sensor of the tool.

15. The system of claim 14, wherein the signal indicative of the output from at least one sensor corresponding to the gesture comprises a signal measured by a depth counter corresponding to at least one change in depth of the tool.

16. The system of claim 14, wherein the signal indicative of the output from at least one sensor corresponding to the gesture comprises a signal from an inertial sensor of the tool.

17. The system of claim 14, further comprising:
an inertial sensor configured to be in communication with the computing device;
wherein the memory comprises instructions that, when executed by the at least one processor, cause the at least one processor to:
receive, from the inertial sensor, a signal indicative of vibrations above a threshold or a wireline slippage detection; and
prevent, by the computing device, the initialization of at least one orientation sensor in response to receiving the signal indicative of vibrations above the threshold or a wireline slippage detection.

18. The system of claim 17, wherein the system comprises a depth counter that is configured to couple to the wireline, wherein the depth counter comprises the inertial sensor.

19. The system of claim 14, wherein the initialization of at least one orientation sensor comprises storing at least one orientation measurement.

20. The system of claim 19, wherein the computing device is configured to store the at least one orientation measurement in memory of the computing device or memory in communication with the computing device.

21. The system of claim 19, wherein the tool is configured to store the at least one orientation measurement in memory of the tool.

22. The system of claim 19, wherein storing at least one orientation measurement comprises storing an azimuth measurement and a dip measurement.

23. (canceled)

24. The system of claim 14, wherein the computing device is configured to cause the initialization in response to a user providing an input from an input device.

25. The system of claim 14, further comprising a display device in communication with the computing device, wherein the computing device is configured to output, on the display device, an instruction to perform the gesture.

26. The system of claim 14, wherein the gesture comprises at least one of:
moving the tool down the drill string; or
moving the tool up the drill string.
